(19) United States
(12) Patent Application Publication
(10) Pub. No.: US 2009/0007192 A1
(43) Pub. Date: Jan. 1, 2009

(54) ON BOARD WIRELESS DIGITAL ENTERTAINMENT, COMMUNICATION AND INFORMATION SYSTEM FOR MASS TRANSPORTATION MEDIUM

(76) Inventor: GAJENDRA PRASAD SINGH, SUNNYVALE, CA (US)

Correspondence Address: GAAJENDRA PRASAD SINGH, 225 LOMETA AVE #11, SUNNYVALE, CA, 94086, US

(21) Appl. No.: 12/144,903

(22) Filed: Jun. 24, 2008

Related U.S. Application Data
(60) Provisional application No. 60/946,870, filed on Jun. 28, 2007.

(51) Int. Cl. H04N 7/18; H04Q 7/20

(52) U.S. Cl. 725/75; 370/338

(57) ABSTRACT

System and method for on board digital entertainment, communication and information system for mass transportation medium (static or mobile) is presented. The system consists of server, software algorithm and client devices. Client devices are connected wirelessly to the server and the server is connected to other servers and external medium wirelessly thereby providing seamless connectivity to the client devices to the server and to outside world. A server design is presented with multiple redundancies to provide un-interrupted services. A client design is presented that enables connectivity to a known server and can be manufactured with low cost. A software algorithm is presented that can prioritize among multiple tasks.

### FIELD OF INVENTION

Present invention relates to an on board wireless digital entertainment, communication & information system for mass transportation medium (MMTM).

### BACKGROUND OF INVENTION

Passenger rail cars typically provide no entertainment for passengers who have no other alternative but to entertain themselves by reading and gossiping at present. Passengers traveling aboard present railroad system are devoid facilities like individual stand alone onboard mobile communication facility, real time information like city information they are passing through, location indicator en route their destination, connecting train information at destination etc. and reliable onboard internet access. The present onboard system does not provide any means for data communication between locomotive crew and the guard in the rear coach of the rail cars, neither does it have any coach to coach communication facility which is of utmost importance in case of emergencies like fire, medical etc. Present system fails to provide a reliable communication link between the crews of the two railcars or trains passing each other and headed in opposite or same directions which can be of crucial importance for conveying information that can prevent accidents or other disaster. Present system fails to provide a credible disaster recovery and salvage operation means in case of rail disasters and lacks any means to record the communication between the crews on board a railcar and between the crews of trains passing each other in same or opposite directions that may prove crucial during disaster investigations.

### OBJECT OF INVENTION

The object of the present invention is to provide a wireless digital entertainment, communication and information system onboard “cells” of a mass transportation medium such as railcars, buses and the likes.

### SUMMARY OF THE INVENTION

The present invention provides an onboard wireless digital entertainment, communication & information system for mass transportation medium comprising:
a server placed onboard each cell of the mass transportation medium which communicates with alien networks, satellites, cellular networks, and with other servers provided onboard other connected “cells” of said mass transportation medium and also with those in the “cells” of other mass transportation medium moving in the vicinity of said mass transportation medium.
said server is wirelessly/hardwired connected to:
   one or plurality of client devices for delivery of multimedia content to the users and communication and information transfer to and from the users in said mass transportation medium
   printer for printing tickets & other information
   administration and supervision control module used by supervisors of said mass transportation medium
   theft detection module for detecting theft of the system components
   theft deference module to deter any theft attempt
   one or plurality of antenna for wireless communication
said server can be fixed in the cell or it can be portable such that it can be removed from the “cell” of the mass transportation medium when desired
said server can be placed in a fixed socket in the cell

A “cell” is a coach in railcar, engine in a railcar or another enclosure or open confinement in a railcar or a bus.

Each “cell” of the mass transportation medium is either wirelessly or hardwired connected to each other for communication. Each cell is provided with a server which communicates with alien wireless networks & servers provided in other “cells” of the same mass transportation medium and with servers provided in “cells” of other mass transportation medium in the vicinity.

Changes in location or sequence of “cells” in the mass transportation medium do not affect overall functionality or performance of said “onboard digital entertainment, communication and information system”.

Changes in location of a server inside a “cell” do not affect overall functionality of the “cell” or overall functionality of the server.

Server provided in each “Cells” in the mass transportation medium, is reconfigurable through software or manually such that any alteration in the location, sequence of any cell would not affect the functionality of the whole system or functionality of each cell.

Many design techniques have been incorporated such that this system can recover from hardware and component level failures.

Method of communication from one “cell” to another “cell” can be decided and changed real time either automatically through software or through manual reconfiguration.

Each server provides multimedia content distribution, communication or information transfer services to its own “cell” or other connected “cells”, communicate to other “cells” and/or with the outside world through alien wireless network (such as satellite network, cellular network and the likes)

In the present invention the server connects wirelessly to client devices, printer, administration and control module, theft detection and theft deterrence modules using TUDM (Time and user Division Multiplexing Technique). With this technique each user (Passenger, crew etc) connected to the server would be able to avail his own multimedia content or perform his own communication or information retrieval and transfer activities, order services completely independent of other clients (Passengers/crew). This onboard wireless digital entertainment, communication and information system will provide a completely private and independent control to any user (Passenger/crew) through client devices for all services available in the system.

Time and User Division Multiplexing is an algorithm implemented in wireless or hardwired communication from the one server aboard a “cell” to another server onboard another “cell” and to said client devices, printer, administration and supervision control module, theft detection module and theft deterrence module.

Present invention provides real time information services to the users such as real time news updates, real time ticketing services, real time train information services like approaching platform information (whether it lies to the left or to the right), train schedule updates, expected arrival times, information regarding train connections at the destinations or/and other stations etc.

This present invention provides communication facility between crews of the same mass transportation medium to another mass transportation medium in the vicinity.

Real time information transfer and communication with other mass transportation medium are provided through communication between servers on board “cells” in a mass transportation medium and alien wireless network.

This invention will also provide communication among users within the same mass transportation medium or with the users in another mass transportation medium in the vicinity. One or multiple users communicate to the server using client devices, in their own “cell” or other “cells”, the server will connect to other users or to another server and finally the other server communicates to the other users. Communication between users is facilitated through client devices. Communication between users will always be facilitated and routed through servers. A client device can connect to another client device onboard the same mass transportation medium or other mass transportation medium in the vicinity.

Such connectivity is useful in emergency situations such as medical emergency, fire and likes.

Present invention facilitates effective communication between the train crew in written media. Train crew communicates using client devices that are capable of audio, video, graphics and other visual display. This would lessen the chances of error which may happen in currently available vocal communication methods. Communication is also provided among crews in the same mass transportation medium. Also crew from one mass transportation medium can communicate with crew of another mass transportation medium in vicinity by communication of servers provided onboard each mass transportation medium. Communication among crews of one mass transportation medium and another mass transportation medium is also provided by communication of servers to the alien wireless network. Communication through alien wireless network happens when the crews of two mass transportation medium are far apart and servers onboard the two mass transportation medium cannot reach each other directly because of large distance.

Present invention shall also prove to be a crucial tool during a recovery and salvage operation at times of rail disasters by providing means of communication using a client device. The client device has an emergency button. When this emergency button is pressed, the client device will transmit wirelessly an emergency signal. This emergency signal is radio signal which will be received by a wireless/radio signal scanning device. Thus any survivor stuck in a coach during a railroad disaster can communicate using the client device to a rescue worker equipped with a wireless/radio signal scanner device.

This invention provides an electronic means for recording the communication among crew of same medium or any medium in the vicinity of said medium. This recorded data could be downloaded and analyzed at a later time during the disaster investigations. This recording may be stored in a storage system within the servers or clients provided in mass transportation medium or in storage outside this mass transportation medium.

### BRIEF DESCRIPTION OF DRAWINGS

The objects and advantages of the present invention will become more apparent by describing in detail the preferred embodiments thereof with reference to attached drawings

FIG. 1 Illustrates “cells” of mass transportation medium either hardwired or wirelessly connected for communication with each other and wirelessly to alien networks.

FIG. 2 Illustrates “cells” connected to the alien wireless networks and to each other wirelessly where servers facilitate the wireless communication with help of wireless antennas

FIG. 3 Illustrates a communication mechanism between the servers and alien networks

FIG. 4(a) and FIG. 4(b) Illustrates the communication mechanism between “cells” of a mass transportation medium

FIG. 5 Illustrates the connectivity and system design and various sub-components within a single “cell”.

FIG. 6 Illustrates the block diagram for internal design of a server

FIG. 7 Illustrates server initialization process.

FIG. 8 Illustrates an embodiment for box level design for the client device

FIG. 9 Illustrates component level block diagram for internal design of a client device.

FIGS. 10(a), 10(b) and 10(c) Illustrates Time and User Division Multiplexing (TUDM) method

FIGS. 11(a) and 11(b) Illustrate communication between users within same “cell” or users within separate “cells”.

FIG. 12 of present invention illustrates top level decision and action mechanism for “Time and User Division multiplexing” algorithm

FIG. 13 of present invention illustrates time and User Division multiplexing algorithm normal mode operation flow chart

### DETAILED DESCRIPTION OF THE INVENTION

Objects and embodiments of the present invention will be more apparent from the following detailed description.

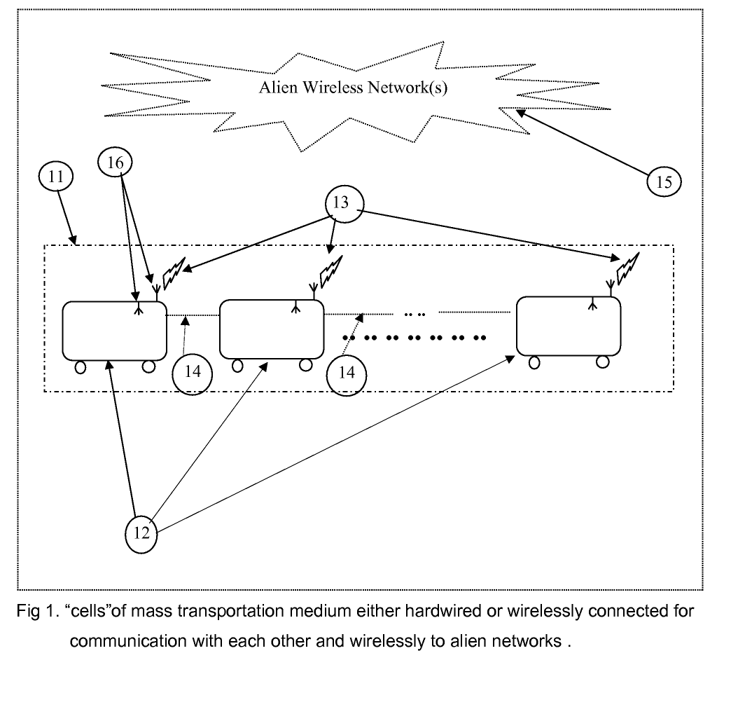

FIG. 1 of present invention illustrates “cells” of a mass transportation medium 11 either hardwired or wirelessly connected for communication with each other and wirelessly to the alien networks comprising one or multiple 12 “cells” connected to each other for communication either wirelessly 13 or through hardwired connections 14 and connected to the alien wireless networks 15 wirelessly. Each “cell” communicates wirelessly to other “cells” and said “alien wireless networks using “wireless antenna” 16. Each “cell” can communicates to other “cells” through hardwired connections 14.

Each “cell” can communicate to other “cell” and to alien wireless networks regardless of its position and sequence in the mass transportation medium. Each “cell” can perform all communication and information transfer functions to other “cells” even if one or multiple “cells” become non-operational due to any reason. Change in location and sequence of “cells” within the mass transportation medium does not affect overall functionality of the cell or overall functionality and performance of the onboard digital entertainment, communication and information system.

The alien wireless networks could be any commercially deployed wireless networks and services such as cellular networks, satellite networks and the likes. The alien wireless network communicates to “cells” through wireless antenna 16.

The wireless antenna 16 could be any commercially available wireless antenna or specially designed wireless antenna attached to each “cell”. The antenna is placed at appropriate location inside the “cell” or atop the “cell”. The hardwire connections 14 are used for high speed communication. These could be commercially available wires such as coaxial cable and likes or especially designed cables for use in this system.

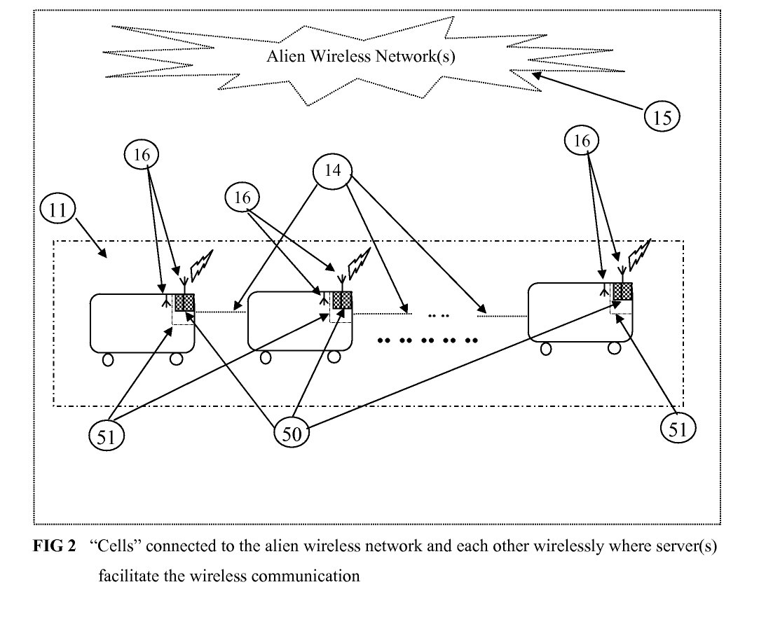

FIG. 2 of the present invention illustrates “cells” each comprising of a server 50. This server is the master control and service provider for all communication and information transfer functions. The server also performs many other services and functions. Each server is connected wirelessly or through hardwired connections to wireless antenna 16

A server performs many functions as described in later paragraphs.

The server onboard a “cell” is placed at any convenient location within the “cell” and would be generally placed in a “server socket” 51 in the “cell”. Change in location of the server within the “cell” does not make any difference in overall functionality of the server or quality of services, facilities and information offered to the users.

Connectivity from one “cell” to other “cell” is configurable through software or manually. In one embodiment communication between one server and other server and communication with the alien wireless network is self repairing/self correcting. Method of communication from one cell to other cell can be decided and changed real time and dynamically through automatic software mechanism or manually.

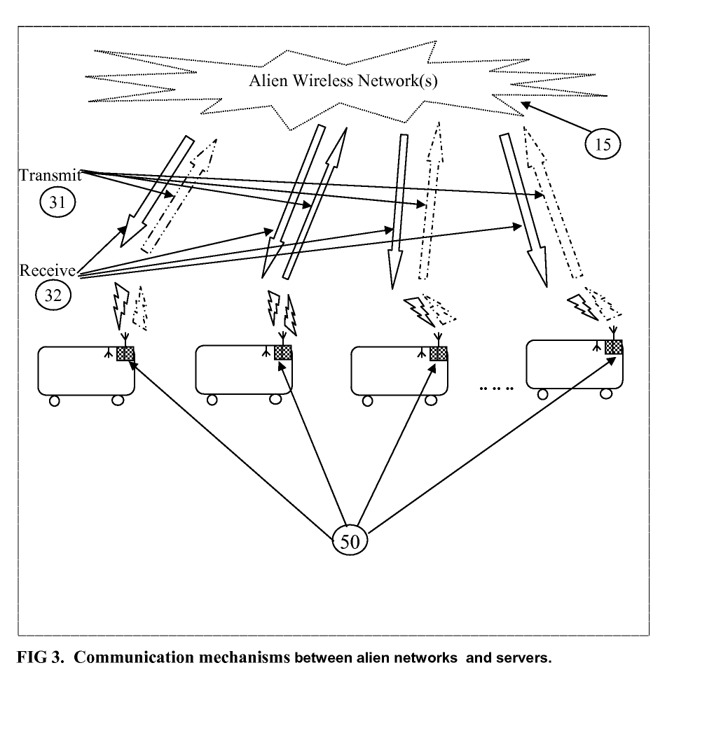

FIG. 3 of present invention illustrates method of communication between servers 50 onboard cells in the “mass communication medium” and the alien wireless networks. All servers receive data from alien wireless network simultaneously as shown by 32. However, only one server at a time will be sending data to the alien wireless networks as shown by 31. This method increases total available data bandwidth for communication to alien wireless networks and preserves precious communication resources that will be otherwise wasted if all servers were sending data to the external network. If a server communicating to the alien wireless networks becomes non-functional another server will automatically take up the role of sending data to the external network. This change in configuration and repair is done automatically through software. The change in configuration and repair can also be done manually. This method provides highly reliable communication to outside world.

All servers can receive the data simultaneously from alien network thereby increasing the reliability and speed of communication. Receiving data simultaneously doesn't cost more data bandwidth and hence is used to maximize effective received data bandwidth.

In another embodiment, some or all servers transmit data simultaneously to the alien wireless networks.

In yet another embodiment, only one or some server receives data simultaneously from alien wireless networks.

This change in configuration of to decide upon servers in the transmitting data simultaneously to the alien wireless networks and/or how many servers receive data simultaneously is done automatically through software or through manual operation or through a combination of both.

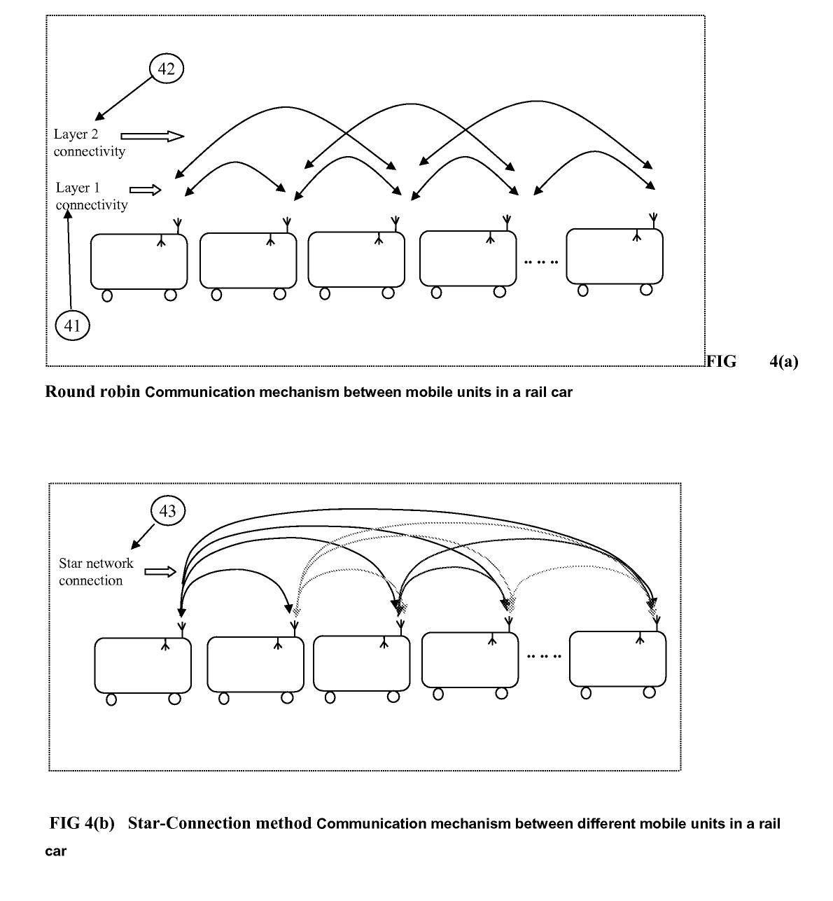

FIG. 4(a) of the present invention illustrates the method of communication from one “cell” to any other “cell” in round robin mechanism. Communication from one “cell” to another “cells” is implemented in dual round robin link as shown in the figure. “Layer 1” connectivity 41 from one “cell” to neighboring “cell” is implemented wirelessly or through hardwired connections. “Layer 2” connectivity 42 from any “cell” to the second neighbor, skipping the immediate neighbor is implemented wirelessly or through hardwired connectivity. This redundancy in form of dual links is used for increasing reliability of communication. Even if one link between any two “cells” becomes dysfunctional, the communication will still happen through the other link. For example if a ring in Layer 1 chain is broken the communication will take place through Layer 2 connectivity. The change in connectivity from Layer 1 link to Layer 2 link or vice-versa is managed automatically through software or manually. Automatic reconfiguration through software provides self repairing functionality. This way, server from one “cell” will be capable of communicating to server in another “cell” through any available link. Connection from a “cell” to any other “cell” will be functional as long as at least one of the links for each “cell” is functional. If both links of a particular “cell” are dysfunctional, that particular “cell” gets disconnected from the chain but all other “cells” will still remain connected to each other. This mechanism provides both high bandwidth and reliable communication between “cells” onboard the mass transportation medium.

FIG. 4(b) of the present invention illustrates communication from one “cell” to any other “cell” using star connectivity mechanism 43. Star connectivity mechanism is used to achieve highly reliable communication between servers on board the mass transportation medium. In this mechanism any server can communicate to any other server directly and independently on board the mass transportation medium.

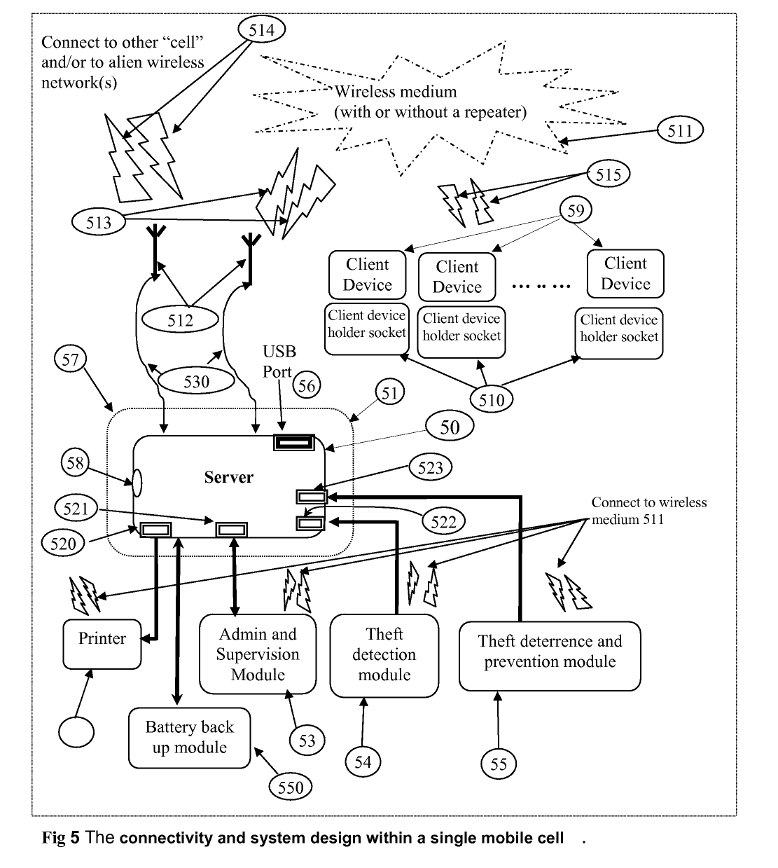

FIG. 5 of the present invention illustrates a block diagram of system design and connectivity onboard a single “cell”.

The “cell” comprises of a server 50. A server does one, multiple or all of following tasks:
work as a “multimedia service provider Server” to provide multimedia contents to users
work as a “communication services provider Server”, to communicate to client devices 59 within same or other “cells” other servers on the same mass transportation medium or mass transportation medium in the vicinity and “alien wireless network”.
work as a “reconfiguration server” to reconfigure its own functionality or functionality of other servers on the mass transportation medium,
work as a “Printer sever”
work as a “theft detection and theft deterrence server”,
work as an “emergency response server”
work as “information technology services provider server”
work as “authentication and usage control and monitoring server”
works as server for management, data collection, data filtering and other data processing activities required for control, service providing, communication, authentication, configuration setting, status logging, information delivery, information processing and other system control functionality

A server can be placed at any convenient location within a cell. Location and sequence of “cells” or servers will not make any difference in overall functionality or quality of services and facilities offered.

The “cell” also comprises of one or multiple “client devices” 59. The client devices are connected to the server using wireless medium 511 or through wires. Client devices perform one or multiple of following function:
Multimedia content delivery to users, communication to the servers and other users, provide information technology based services to users, communicate emergency information to servers, theft deterrence and help in theft prevention and disaster assistance transmission.

The client devices 59 are portable. A client device can be temporarily stored in the “client device socket” for charging, holding, temporarily stowing or for other purposes. They can be removed from a “cell” by pre-determined appropriate authentication process.

The client devices receives multimedia content and other data from the server and transmits information, data, user based instructions and status to the server. The client devices facilitate to provide a seamless multimedia experience to the users, facilitate communication from one user to other users on the mass transportation medium through servers, facilitates communication between users and other person or machine outside mass transportation medium through servers and alien wireless networks, provides means for availing information technology based services such as ticket printing, destination information, hotel/car booking services at the destination or other locations and likes, provide means for receiving and sending information to other users, provide means for emergency information communication, provide means availing assistance in situation of disasters, provide theft deterrence functionality.

The server 50 consists of one or multiple wired USB ports 56 that can be used for multiple purposes. These USB ports are used to connect a compatible device to the server. At any time one or multiple devices can be connected to USB ports. These USB ports are publicly available commercial ports.

The server also consists of a supply connection port 58 that supplies power to the server, charges battery in the server or charges a battery back up unit 550 through the server.

A “cell” comprises of battery “back up module” 550. This module can be a portable or fixed component in the “cell”. The “battery back up module” supplies power to the server if required.

In another embodiment of the invention the “battery back up module” may be integrated in the server and hence it will be built in the server.

In yet another embodiment of the invention the “battery back up module” may not be required and can get its supply from the cell battery bank.

A “cell” comprises of a printer 52. The printer is connected to the server through a special printer port 520 in the server, or to one of the USB ports through hard wire or through wireless medium 511. This printer may draw power from the printer port 520 or can use rechargeable battery devices. This printer is a commercially available printer or a special printer designed for this system. The printer can be a fixed device in the “cell” or a portable device that can be removed from the “cell” using a predetermined procedure of authentication.

In another embodiment printer is physically integrated or is built in the server and it is be part of the server itself. No connector will be needed separately. The inbuilt printer may not need any external connectivity but will require human interface devices such as key pad display and likes.

In an embodiment the printer operates only with admin/supervisor authentication in normal mode and without admin/supervisor authentication in debug, service, status, emergency or special functionality mode. In yet another embodiment the printer operates without special authentication.

“Admin and Supervision module” 53 is an independent portable or fixed device that connects to the server through a special admin and supervision port 521 or through the USB ports 56 using hard wire or wirelessly through the wireless medium 511.

In another embodiment the “admin and supervision” module is physically built in and part of the server itself and it is integrated in the server body. To operate the in-built “admin and supervision” module an extra key pad and display mechanism is required.

The “Admin and Supervision module” 53 is specially designed to do one, some or all of following activities for the server and other components in the “cells” supervise, administer, control, debug, operate, override, access, status check, customer service, disaster scanning, emergency response assistance, communication control, billing, authentication of any activity and similar activities.

In one embodiment the “admin and supervision module” 53 requires authentication for using and controlling this device.

In another embodiment the “admin and supervision module” 53 does not require authentication for usage.

Administration and control module is used by supervisors of mass communication medium.

A cell also comprises of a “theft detection module” 54. The “theft detection module” is a combination of wireless or infrared, another wireless detection mechanism or a mechanical device or a magnetic device or any combination of wireless, infrared, mechanical, electrical or magnetic mechanism that will detect and warn about a client device or any other component that is part of this “on board digital entertainment, communication and information system” being taken outside a permitted area With being disabled from the server.

The “theft detection module” is connected to a special port 522 in the server or a one of the USB ports 56 using hard wire or through “wireless medium” 511 wirelessly. Once such a suspicious activity is detected, this module will send an alarm to the server.

In case of a theft activity the “theft detection module” detects the theft and communicates the “theft threat” to the server. Server will determine the validity of such a “theft threat” and takes appropriate action by activating “theft deterrence and activation modules” 55 if the threat is valid or by ignoring the “theft threat” if the threat is invalid. The server also communicates the “theft threat” information to the “admin and supervision module” 53 which is used by supervisors in the mass transportation medium to take appropriate action of deterrence and prevention of theft activities. The server also communicates a valid “theft threat” information to appropriate client device. The particular client devices uses this information to activate its own theft deterrence mechanism.

Every client device or other devices on board “cells” in this “onboard entertainment, communication and information system” has digital identity that will be stored in all servers. Only authenticated client devices or other devices used in the system can connect to the server. This authentication is provided by the server following certain pre determined constraints or through manual override.

All activities, communications and usage of each client device and other components used within this system will be logged by the system within the server and maintained for future analysis.

A “cell” also comprises of server socket 51. A socket is located at appropriate place in the “cell” with a power supply plug and connectivity wires 530 to connect to one or multiple antenna 512. Server socket 510 holds/supports/houses the server 50 within this socket using a mechanical lock, a magnetic lock, an electrical lock or a combination of them. This lock is opened with a mechanical key or a digital key or with another appropriate key.

In another embodiment the digital key is administered using “supervision and administration control” device.

In yet another embodiment server socket may not require power connectivity. In that case the server will get power from its own battery or through rechargeable battery or through another portable power supply mechanism.

Server is removed from its socket by the supervisor with authentication control or without depending on requirements.

The “cell” also comprises of one or multiple “client device sockets” 510. These are enclosures or sockets for support, charging, temporary docking, temporary or permanent stowing, locking, protecting or any combination of above activities for the client devices 59. Client devices are docked or placed temporarily when the user a passenger or crew is not using it. These sockets 510 are designed to have a locking mechanism and a power plug.

Locking mechanism is mechanical or electrical or magnetic mechanism that is operated either through mechanical key or through a digital key that is entered through an authentication card or through a password that can be entered using keypad in the client device.

In another embodiment of the “cell” these “client device sockets” may not need any locking mechanism. In yet another embodiment these “client device sockets” do not have power connectivity. In yet another embodiment the “client device sockets” can be portable.

The “cell” also comprises of one or multiple antennas 512 that are connected to the server through hard wires or wireless connections. These antennas facilitate the wireless communication between two servers, between servers and client devices, between server and other components within one or multiple “cells”. These antennas also facilitate communication between servers on board the mass transportation medium and the “alien wireless networks”.

A cell also comprises of “wireless medium” 511. This may consist of one or multiple repeater antenna, one or multiple wireless repeater devices or all or none of these.

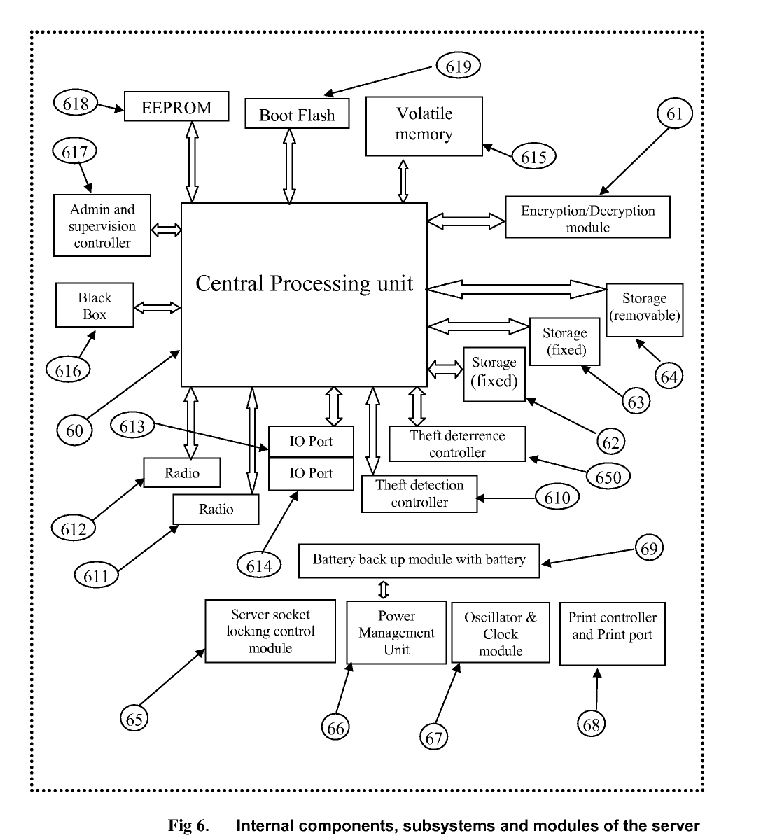

FIG. 6 of the present invention illustrates block diagram for internal design of the server. The server in present invention comprises of a central processing unit 60, two fixed storage devices 62 and 63, one removable storage device 64, encryption/Decryption module 61, volatile memory 615, boot flash 619, EEPROM 618, admin and supervision controller 617, black box 616, two radio module 611 and 612, IO Ports 614, theft detection controller 610, theft deterrence controller 650, battery backup module with battery 69, print controller print port module 68, Oscillator and clock module 67, power management unit 66 and server socket locking control module 65.

Multiple implementations of server internal design are possible with a combination of components listed in paragraph above. For example, in one embodiment only one fixed storage device is used instead of two. In another embodiment the “battery backup module with battery” 69 is outside the server and connected to the server through a port. In yet another embodiment only one or multiple radio can be used. In yet another embodiment multiple modules can be built-in into the “central processing unit” 60.

The central processing unit 60 where said central processing unit comprises of one or multiple processors and one or multiple bridge chips.

Said storage devices 62, 63, 64 are re-writable storage devices such as flash memory, disc, DVD, CD and likes.

All the storage devices 62, 63, 64 will have encrypted data on them. In all cases there is at least one removable storage device in the server connected to the “central processing unit” 60.

Two fixed storage devices 62, 63 are used for fault tolerance feature in the system. In case one of the hard disk gets faulty, the other disk will provide data thereby increasing reliability of operation for the system. Both fixed hard disks will get copy of data from the removable hard disk. Copy operation will be undertaken by the server during system initialization. No manual intervention is needed in this copy operation. This mechanism guarantees that no data piracy can take place in the system in present invention.

The “theft detection controller” 610 will receive a “theft threat” information and process it for authenticity, validity and other verification. Then it passes the information to said “theft deterrence controller” 650 that decides on theft deterrence activity, controls the theft deterrence mechanisms and procedures and controls theft deterrence module 650 and theft deterrence mechanism in client devices. Theft deterrence module 650 in conjunction with the client devices 59 will provide the theft deterrence Functionality. The server also comprises of a “Black Box” 616. The “black box” records user communication data, emergency activation data and other information. The recording is performed and controlled by the server. Before the data is stored in the black box device, it will be encrypted. The black box comprises of a non-volatile storage medium (like flash memory, hard disk etc) that will be enclosed in a hard casing. The hard casing will be made of pre-selected material that can withstand high pressure, extreme shock and other harsh conditions that can be present during an accident. The black box device will have a rechargeable battery that will be connected to the system only when the system is not shut down properly. Hence in case of an accident, the battery will get connected and will activate a wireless beacon that can be detected through a wireless detection mechanism.

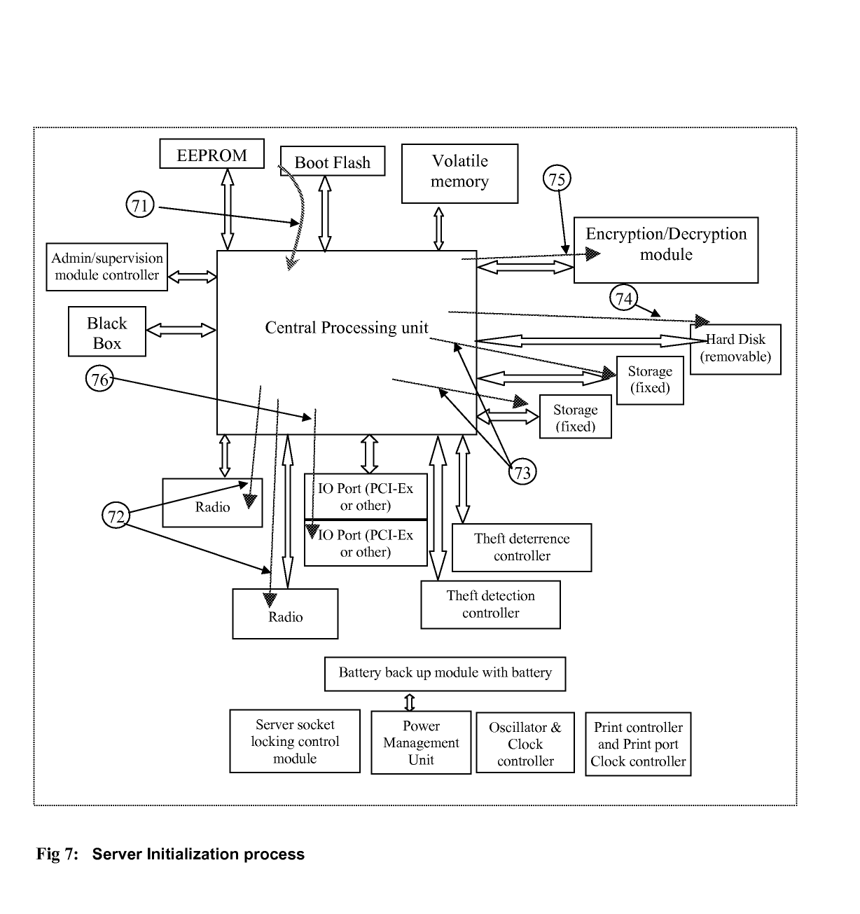

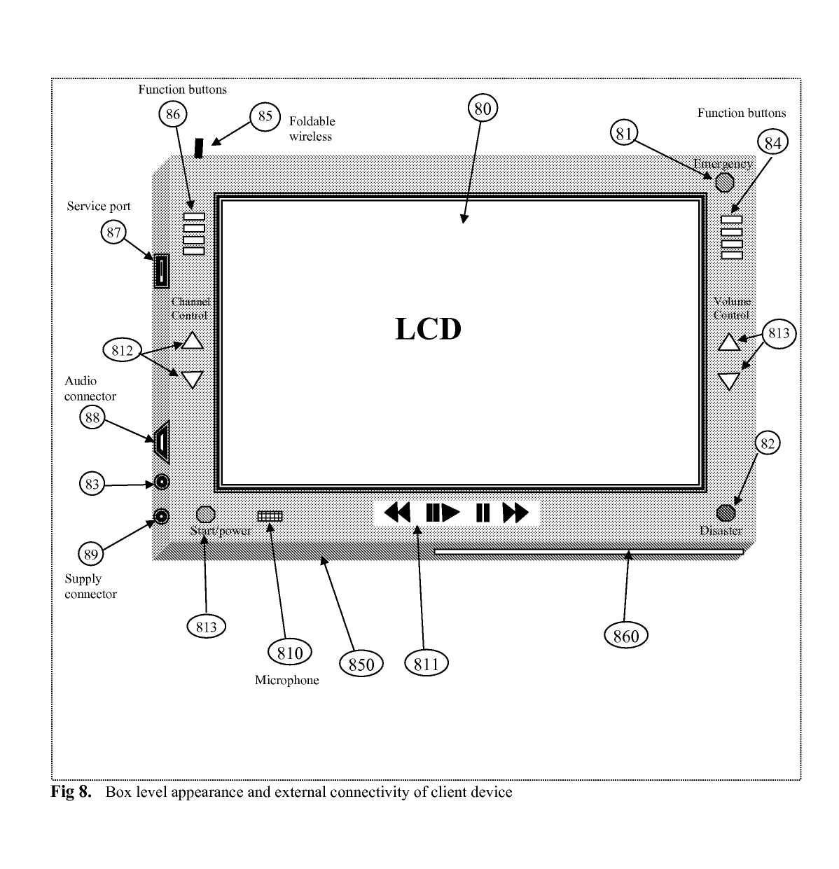

FIG. 7 of the present invention illustrates server—initialization process. In this process the server initializes itself, all sub-components in the whole system of onboard digital entertainment, communication and information system. In this initialization process all sub-components of the system including all client devices, theft deterrence mechanism, theft detection mechanism, communication to the “alien wireless networks”, communication to other servers in the mass transportation medium, admin and supervision module in a cell, printer, wireless link etc. All subcomponents are checked for functionality, activity and authenticity. Communication links to other servers are established, verified and authenticated. Communication to alien wireless system is initialized, verified authenticated and tested. Status and role of each server connected together onboard the same mass transportation medium and other mass transportation medium in vicinity is negotiated using automatic software protocols and controlled either automatically through software using pre-determined rules or by manual setup performed using “admin and supervision module”.

Initialization program is stored in the Boot Flash/EPROM device. Programs are fetched from Boot Flash/EEPROM device as shown by 71 and executed by the central processing unit. Central processing unit will take required action by fetching further instructions from boot flash/EEPROM device and sending initialization instructions to storage devices, radios, IO ports, encryption/decryption module, volatile memory and other subcomponent.

FIG. 8 of present invention illustrates external design, appearance and connectivity of a “client device”.

A client device externally comprises of a LCD screen 80, metal or plastic case 850, distributed key pads 813, 811, 82, 84, 81, 86 and 812 for various functionality, a metal frame 850, a microphone device 810, a supply connector 89, an audio connector 88 to connect headphones, service port 87 for various controls, debug, servicing, programming and maintenance functionality, billing or credit card reader 860, communication port 83 to connect to server through hardwire and a wireless antenna 85 for wireless communication.

In another embodiment the antenna 85 is enclosed within the client device and is not visible outside the device.

In yet another embodiment the audio connector 88 is of a different shape. The audio connector is one of the commercially available audio connector or a specially designed audio connector.

In yet another embodiment various external components of the “client device” may be placed in locations other than shown in this figure.

In yet another embodiment the “client device” will have different number of functional keys than shown in the figure.

In yet another embodiment, key pads 812, 811, 83, 84 and 86 can be of other shapes and sizes so as to improve the aesthetic looks of the client device.

Key pads in the client devices can be commercially available flexible key pads or mechanical keys.

Emergency and Disaster buttons will be designed such that they will be clearly and distinctly visible.

In another embodiment the emergency and disaster buttons 81 and 82 respectively will not be easily operated and may require more pressure to avoid accidental activation of these keys.

The microphone 810 is a commercially available microphone or a especially designed microphone for this client device.

The LCD screen 80 is a commercially available LCD screen with form factor customized for this “client device”.

The service port 87 is either a commercially available USB port or a especially designed connector for this “client device”.

Supply connector 89 can also be a commercially available connector or a especially designed connector for this client device.

Billing card reader 860 is a groove with mechanism to read credit card or a billing card for billing of services availed by users.

Client device externally comprises of a communication port 83 which is used to connect to the client device to the server using hard wire.

In other embodiments of the client device color, locations, shapes, sizes of various external subcomponents of the client device may be different than the shown in the FIG. 8.

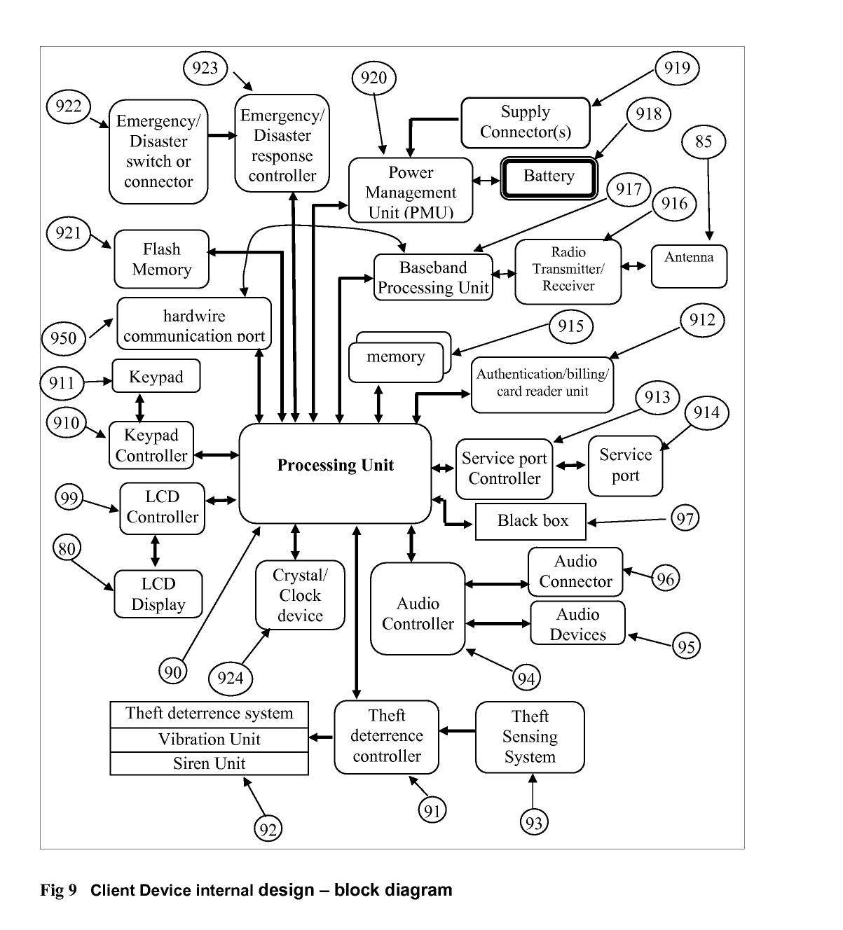

FIG. 9 Of present invention illustrates the block diagram for internal design of the client device.

The client device comprises of a processing unit 90 that is connected to:
LCD controller module 99 for controlling LCD displays 80. LCD display is a commercially available LCD display device with form factor designed specially for this “client device”. The LCD controller is implemented in software or hardware or a combination of the two.
Key pad controller 910 and key pad 911 where Key pad consists of plurality of functional buttons with various sizes, colors and shapes. Said buttons are placed at various locations of the “client device”. User can input its control, information, priority, data and other inputs to the client device using key pads. Users can also pass messages, play games, and communicate to the server or outside world through alien wireless networks with help of these keypads. In case of emergency a user can use “emergency” button to avail assistance and inform other users, crew or appropriate authority of emergency situation. In a disaster situation the “disaster” button can be used to activate disaster assistance request.
Hardwire communication port 950 that is also connected to the baseband processing unit. This is the alternate communication method between the servers and the client device in case the wireless communication fails or cannot be used for some reason.
Flash memory 921 that contains program memory and other important information such as functioning, authenticity, activity, status, control, registration, service quality and likes. This is a commercially available non-volatile memory device.
Emergency response controller 923 connected to emergency switch/connector that can be used by any user to inform about an emergency situation and request emergency response by the crew or other authority of mass transportation medium. The emergency response controller comprises of both hardware and software components.
Power management unit (PMU) 920 which is in turn connected to supply connectors 919 and battery 918. Power management unit is interface between external power supply outlet and the client device. It generates all the necessary voltages for various sub-components in the client device. The power supply unit also controls charging of the battery 918 if needed. It also controls the power supply distribution from power outlet or battery as and when needed. When power is supplied by an external power source (such as supply outlet or stowed in the client device socket) the battery 918 is charged and all sub-components of the client device get power from the external power source. When no external power source is available, battery supplies power to all sub-components of the client device through power management unit.
A baseband processor 917 which is further connected to the radio transmitter/receiver module 916. The radio transmitter/receiver unit is further connected to an antenna 85. Radio transmitter/receiver 916 provides wireless communication between servers and the client device through the antenna 960. Baseband takes the wireless radio data and converts it into usable data that can be used by other units of the client device. The baseband device is a commercially available baseband device or specially designed baseband device for this client device. The baseband processor 917 is also connected to the hard wired communication port for processing communication data in case wireless communication is not being used or for some other reason that requires hard wired communication.
Authentication/billing and card reader unit 912 that reads a credit card, a billing card or some other card for billing, control, authentication, service request, information transfer, debugging and servicing functions.
Memory devices 915 for temporary storage of data. These are commercially available volatile memory devices.
Service port controller 913 that is further connected to service port 914 for debugging, authentication, servicing, information transfer, data analysis, maintenance operations. The service port controller and service port could be commercially available IO port or a specially designed port with electrical connectivity, supply specification and other communication features.
Black box 97. This is a specially designed storage unit with battery, beacon transmitter and shock, impact, fire and other disaster proof casing. This black box stores vital information of user activities that can be used for disaster analysis in case of a disaster. The data in black box is encrypted and it can be viewed and used only by appropriate authority.
Audio controller 94 which is further connected to audio connector 96 and to the audio device 95. Audio controller along with audio connector and audio devices provide audio delivery and audio receiving facility to the client device.
Theft deterrence controller 91 which is further connected to theft sensing system 93, and theft deterrence system 92. Theft deterrence controller along with theft sensing system and theft deterrence system help in reducing theft of the client devices from mass transportation medium. This is important for reducing loss of property and provides enormous business advantage.
Crystal/clock generating device for generating clock pulses that are used by processing unit and other sub components in the client device for digital operation.

A client device after start up operates in following functional modes a preview mode, a normal mode, a stowed mode and a theft deterrence mode, or disaster assistance mode

These different modes of operation (start up mode, preview mode, normal mode, stowed away mode or/and theft deterrence mode) of the client's device can be better understood with following description.

When power is switched on the client device displays the welcome message. Simultaneously the client sends the “wake-up and register” status to the server through wireless medium. The server registers and checks the authenticity of the client. Once the client is verified as one of the valid clients it registers this client as alive and reserves a time slot “ ” for this client. Then the server sends all available multimedia content indexes to the client. The client device then displays the index on its screen. If this index is large and cannot be displayed in one screen the user has option to scroll up and down through the multimedia content using key pads. This scrolling functionality is controlled and monitored by the client device. Server sends all the index information to the client at one time. In another embodiment the server and client implement a software handshaking mechanism wherein the server send only the information that has been requested by the client device. This handshaking mechanism is useful when viewing information, news or other non video contents or availing information services.

In the preview mode after viewing the multimedia content a user can request preview of any index item. The client will send a preview request to the server through Wireless communication medium. The server will check the identity of the user and send the preview data to the user without any check for billing information. User can see the preview information about any program at any time. Additionally there can be filtering of preview information based on service type assigned to a user. Type of service will be assigned based on payment or any other criteria that is suited for this classification.

Normal functionality mode can be entered after a preview mode or in any other mode. In normal functionality the client requests for a multimedia content to be delivered to him. This is done by simply pushing a button. The client sends an appropriate request to the server. The server will first check the authenticity of the request and do all the necessary check and book-keeping for billing before starting to send the content to the client. In another embodiment of the system check for billing and authenticity may be removed. In yet another embodiment the check can be done selectively based on the request from the client. Client in the mean time will display welcome and copyright information on the screen.

A user can play any multimedia or text based content like movie, sports, lectures etc. A user can rewind, fast forward, pause or skip any content at his will. These controls are similar to controls available in a common video retrieve and display device (like a VCR and TV, or a DVD player etc). User has full control of all contents. For playing games, the user has similar controls available to him as a common game console unit.

In normal mode the client device can also be used for voice or data communication with other users on the same mass transportation medium or to a user outside the mass transportation medium or with the train crew or supervisors of mass transportation medium.

In the stowed Mode the client device can be stowed in a fixed enclosure. This client device enclosure will have a mechanical or magnetic or/and electrical or a combination of these locking mechanism that will lock the client cell in the enclosure and will open only when authenticated either by using an authentication card or some other authentication method through keypad. While stowed away in the enclosure, the client battery will be charged through a built-in charging mechanism in the enclosure.

In another embodiment this stowing mechanism will be removed completely and there will be no stowing enclosure.

In yet another embodiment the stowing unit will only provide facility to lock the client device.

In yet another embodiment of this invention the stowing unit will be one or multiple sockets to only charge the client devices. Any client can be placed in this socket so that the client will be charged.

These sockets can be placed above each seat or under the seat or at another appropriate location.

Another mode of operation is the theft deterrence mode. In this mode the client device will activate a theft deterrence mechanism. In one embodiment the theft deterrence mechanism comprises of siren and vibration cells. Siren cell may be made of a speaker that can play a predetermined sound. The vibration cell may be made up of a mechanical device that will start vibrating. In yet another embodiment the deterrence system can additionally be comprised of lighting mechanism that will generate bright, flickering, alternating some or all of above mechanisms. In yet another embodiment the theft deterrence system may additionally or uniquely be comprised of electrical system in which a known magnitude of current will flow thereby causing a tolerable but shocking sensation to the thief. In yet another embodiment the theft deterrence system may additionally or uniquely be comprised of magnetic mechanism where the client device will be locked and attracted to a magnetic medium.

In an embodiment some or all of above theft deterrence mechanism will be used.

In disaster assistance mode the client device transmits disaster assistance signal continuously that can be scanned by a disaster signal scanning device. This mode is activated through disaster button in the client device.

In a normal mode the client device will be housed within a known boundary. Whenever the client device is taken outside this boundary the theft deterrence mechanism will be activated.

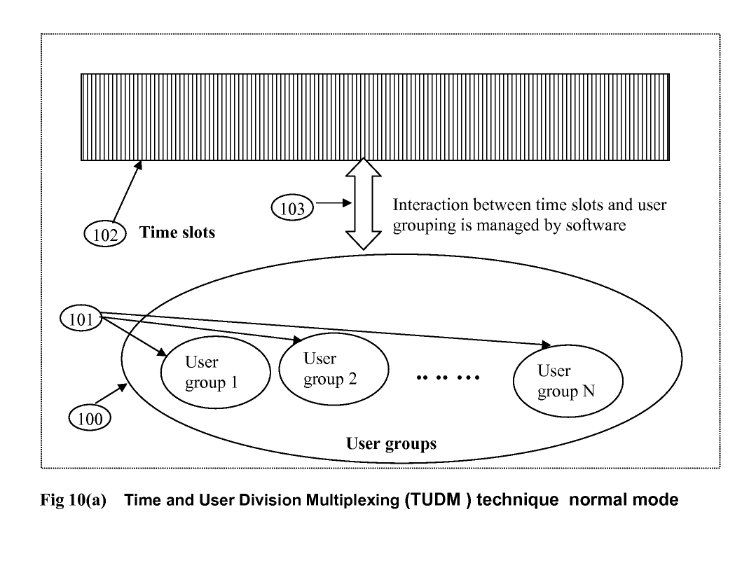

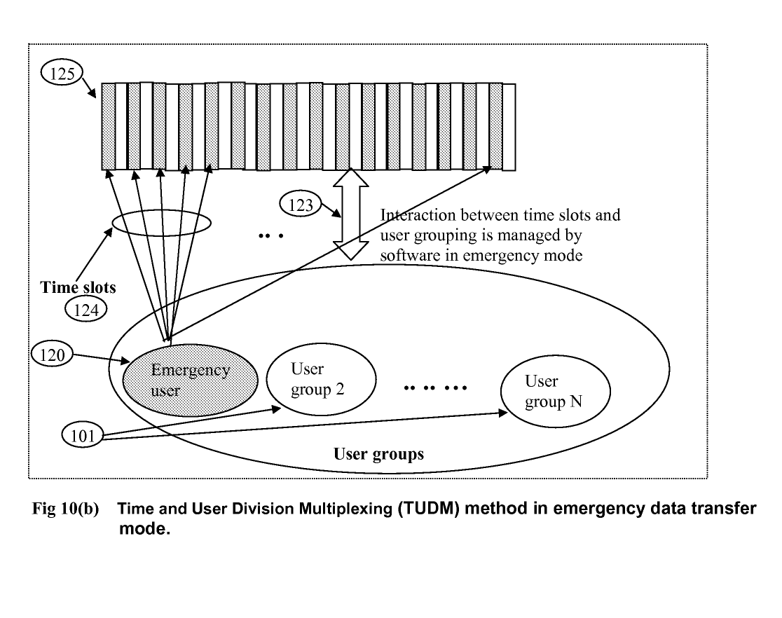

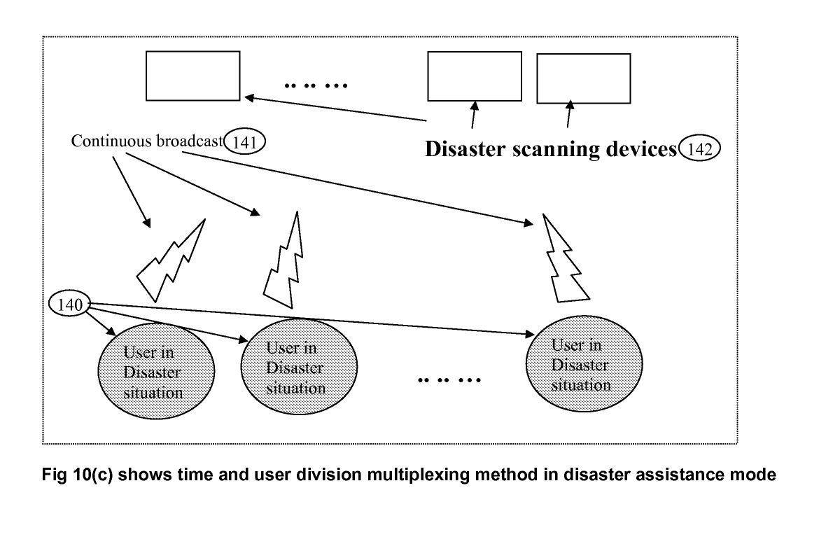

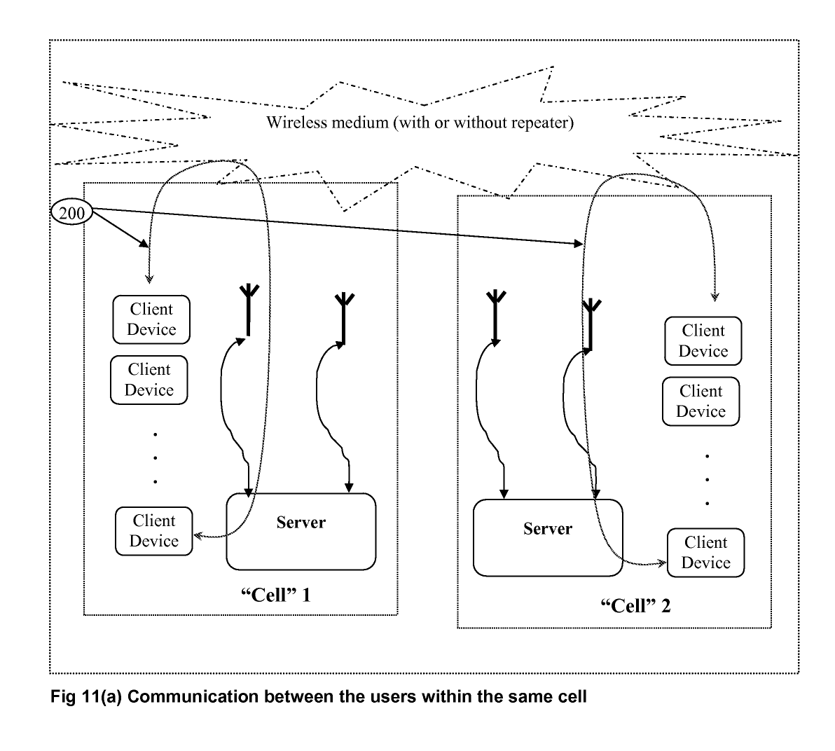

FIG. 10(a), FIG. 10(b) and FIG. 10(c) of present invention illustrate block level diagram of Time and User division multiplexing (TUDM) algorithm. This algorithm is implemented in software. However, hardware design is selected especially to execute this algorithm.

This algorithm divides time in small slots 102 and users in small groups 101. Then it delivers data, multimedia content and other information to client devices in the time slot a fixed set of users. With this communication mechanism a fully independent and personalized seamless entertainment, communication and information experience is provided to all users special provisions have been made in the algorithm to give priority to emergency communication and communication among crew.

In disaster recovery mode data communication is done in broadcast mode on many available frequencies such that disaster scanning device can locate and provide the needed services and rescue.

FIG. 10(a) of present invention illustrates time and user division multiplexing (TUDM) method of communication in normal mode. Time is divided in slots 102 and users are divided in groups 101. Interaction between groups and time slot is controlled by software by the server. Overall communication between groups of people and server is controlled by the server. Especial design techniques are used inside the server to provide a continuous and seamless experience to all users.

FIG. 10(b) of present invention illustrates “time and user division multiplexing” (TUDM) method to communicate emergency data. In this mode the emergency user is separated from its group and assigned an “emergency” status 120. Emergency tunnels 124 are opened in the time domain with communication of the emergency data to the server in many redundant streams. Server will then assemble and decode the information, discard the replication and take appropriate action of transferring information to the supervisor, train crew or communicating it outside the mass transportation medium using alien wireless network for action by management or Government.

In this mode while emergency information is transferred, the system still avails normal services to other users in normal fashion.

FIG. 10(c) of present invention illustrates time and user division multiplexing method and system communication setup in disaster recovery mode. In this method all the time is allotted to user in disaster situation 140. Each client has a unique identity that is broadcasted continuously 141. Rescue personnel will carry “disaster scanning device's 142 that will count active client devices and determine the position and distance of a person in disaster situation from a pre decided client location and client identity available from operator of mass communication medium. In this mode server does not play any role and communication is not done through client devices. Each client device acts as a master in this mode.

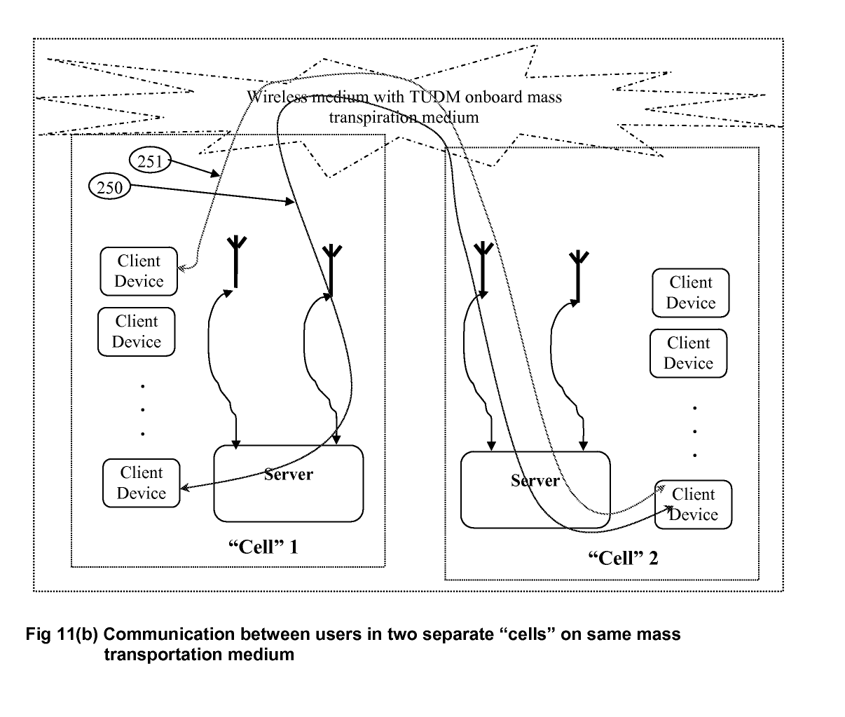

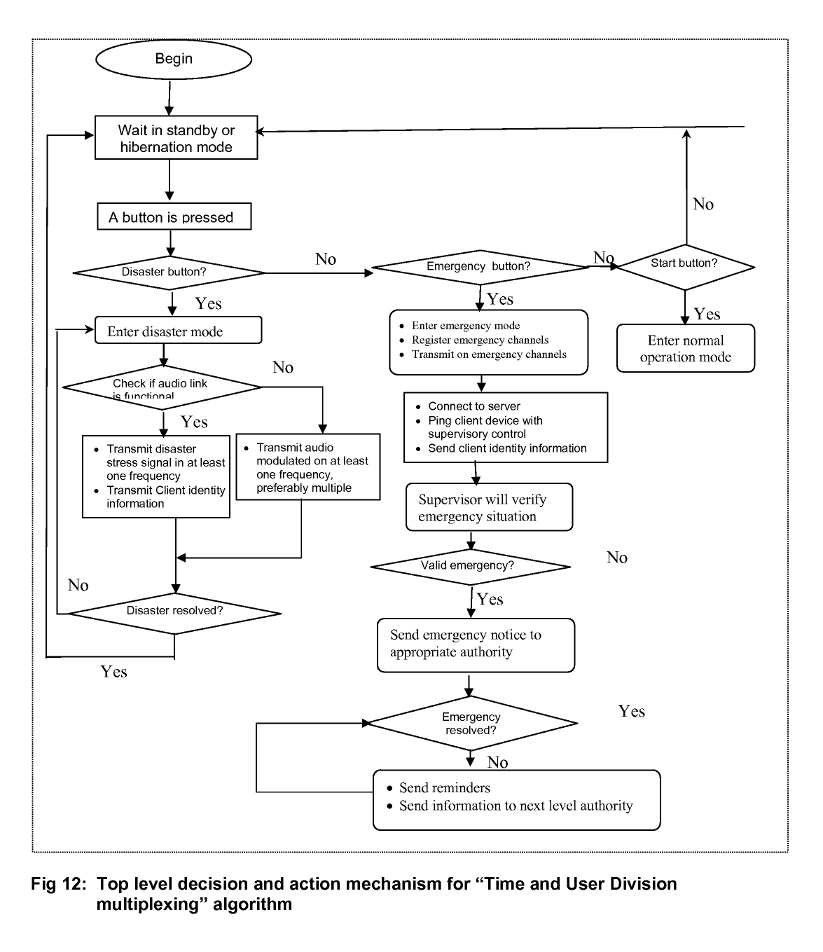

FIG. 11(a) and FIG. 11(b) of present invention illustrate mechanism of communication between two users onboard a mass communication medium.

FIG. 11(a) of present invention illustrates mechanism of communication between multiple users through a single server in the same “cell”.

FIG. 11(b) of present invention illustrates mechanism of communication between multiple users in separate “cells” with help of one or multiple servers

FIG. 12 of present invention illustrates top level decision and action mechanism for “Time and User Division multiplexing” algorithm

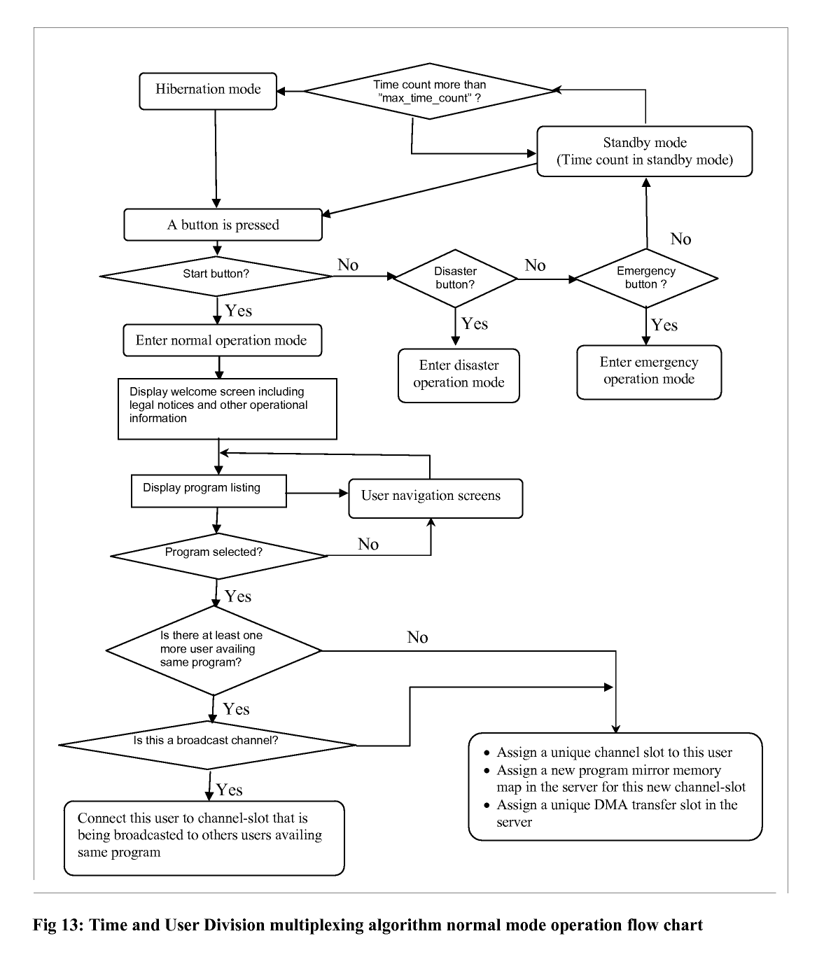

FIG. 13 of present invention illustrates time and User Division multiplexing algorithm normal mode operation flow chart

1. An onboard wireless digital entertainment, communication & information system for mass transportation medium comprising:
a server placed onboard each cell of mass transportation medium which communicates with alien network and with other servers provided onboard other connected “cells” of said mass transportation medium and also with those in “cells” of other mass transportation mediums in the vicinity of said mass transportation medium, said server also communicates to outside world through the alien network
said server is wirelessly and/or hardwired connected to:
one or plurality of client devices for delivery of multimedia content to the users and communication and information transfer to and from the users in said mass transportation mediums
one or multiple printer for printing tickets & other information
administration and supervision module used by supervisors of said mass transportation mediums.
theft detection module for detecting theft of the system components
theft deterrence module to deter any theft attempt
one or plurality of antenna for wireless communication to/from the server
said server is placed in a cell such that it can be removed from the “cell” when desired

2. An onboard wireless digital entertainment, communication & information system as claimed in claim 1 wherein said server is placed in a socket in the cell

3. An onboard wireless digital entertainment, communication & information system as claimed in claim 2 wherein said server is either removably or irremovably fixed in said socket

4. An onboard wireless digital entertainment, communication & information system as claimed in claim 1 wherein the mass transportation medium is either a railcar including engine or a group of busses or a single bus

5. An onboard wireless digital entertainment, communication & information system as claimed in claim 1 wherein said “cell” is a coach in a railcar, an engine in a railcar or another enclosure or open confinement in a railcar or a bus

6. An onboard wireless digital entertainment, communication & information system as claimed in claim 1 wherein alien network is satellite network or cellular network or other communication network

7. An onboard wireless digital entertainment, communication & information system as claimed in claim 1 wherein each server in the cell of the mass transportation mediums is either wirelessly or hardwired connected to other servers in the same mass transportation medium whereas the servers in two different transportation mediums are connected wirelessly only, for communication,

8. An onboard wireless digital entertainment, communication & information system as claimed in claim 1 wherein said server in each “Cell” in the mass transportation mediums, is reconfigurable through software or manually such that any alteration or changes in location or sequence of “cells” or elimination of one or more cells in the mass transportation medium or changes of location of the server inside a cell will not affect overall functionality or performance of said “onboard digital entertainment, communication and information system”.

9. An wireless digital entertainment, communication & information system as claimed in claim 4 wherein the mode of communication from one “cell” to another “cell” is decided and changed real time either automatically through software or through manual reconfiguration

10. An onboard wireless digital entertainment, communication & information system as claimed in claim 1 wherein said server communicates wirelessly to client devices, printer, administration and supervision module, theft detection and theft deterrence module using TUDM (Time and User Division Multiplexing) technique

11. An onboard wireless digital entertainment, communication & information system as claimed in claim 1 wherein each server provides multimedia content distribution, communication or information transfer services to its own “cell” in the mass transportation medium either through wireless/wired communication or through the alien network

12. An onboard wireless digital entertainment, communication and information system as claimed in claim 1 wherein client devices act as crucial tool during a recovery and salvage operation at times of rail disasters by providing communication, the client device has a disaster button, when this disaster button is pressed, the client device will transmit wirelessly a disaster stress signal, this disaster stress signal is radio signal in one or multiple frequencies which will be received by a wireless/radio signal scanning device held by rescuers

13. An onboard wireless digital entertainment, communication & information system as claimed in claim 1 wherein the client device includes an electronic storage device for recording the communication among users in same mass transportation medium or other mass transportation medium in the vicinity, the recorded data is downloaded or transmitted to the device outside the mass transportation medium for analysis

14. An onboard wireless digital entertainment, communication & information system as claimed in claim 1 wherein the server comprising:
a central processing unit for performing control, processing, configuration and programming functions
encryption/decryption module connected to said central processing unit for encryption/decryption of data,
at least two fixed storage devices connected to said central processing unit for storing data
at least one removable storage device connected to said central processing unit for storing data in encrypted form to reduce piracy and easier distribution of multimedia content
at least two IO ports for connecting IO devices, at least one of them is stand by for more reliable operation
theft deterrence controller connected to said central processing unit for controlling said theft deterrence module
theft detection controller connected to said central processing unit for controlling said theft detection module,
at least two radio modules connected to said central processing unit for wireless communication wherein at least one is stand by
a black box connected to said central processing unit or said IO port for storing encrypted data
admin and supervision controller connected to said central processing unit for controlling said admin and supervision module
EEPROM device connected to said central processing unit for program and configuration storage
boot Flash device connected to said processing unit for storing boot program and configuration information
Volatile memory connected to said central processing unit for temporary storage of data and programs

15. An onboard wireless digital entertainment, communication & information system as claimed in claim 1 wherein the server includes:
a power management unit for managing power supply to all components in the server, managing charging the battery and managing current flow from external supply or internal battery.
a battery backup module connected to said power management unit for providing power to the server in absence of external power supply
an oscillator and clock module for providing clock to all digital blocks and analog blocks for functionality and timing reference
printer controller and printer port for connecting to said printer

16. An onboard wireless digital entertainment, communication & information system as claimed in claim 13 wherein said black box is a storage device with shock and impact proof casing to tolerate pressures, shocks and impacts during an accident or other conditions of high stress and shocks

17. An onboard wireless digital entertainment, communication & information system as claimed in claim 1 wherein said client device includes:
an LCD screen,
a Disaster button that is used by an user in case of a disaster situation to activate disaster response behavior of the client device,
an emergency button to be used by an user to activate emergency response of the client device to seek medical, fire, security, police and other emergency assistance from crew, supervisors and other concerned authority,
an audio connector for connecting a headphone or a speaker device or both,
a supply connector for connecting external power supply to the client device,
a service port for debug, control, programming, servicing and accessibility of internal components of the client device,
a foldable wireless antenna for wireless communication of the client device to server in normal and emergency mode and to the disaster scanning devices in disaster mode,
a microphone for voice communication, recording or other voice reception and recognition functionality,
a communication port for wired communication of the client device,
a key pad comprising of at least 4 (four) function buttons for functioning of the client device in normal functionality mode which changes functionality depending on the screen configuration,
a credit card, billing card and/or authentication port/slot for authentication or reading credit card or billing card or other cards

18. An onboard wireless digital entertainment, communication & information system as claimed in claim 1 wherein said client device comprising:
a processing unit for controlling functionality, data processing, controlling communication and other control and management functions
a black box connected to said processing unit for recording predefined information that can be analyzed in situation of emergency and disaster
An emergency and disaster response controller connected to said processing unit for controlling emergency and disaster buttons functionality and activating emergency and disaster response of the client device
A baseband processing unit connected to said processing unit and a hardware communication port for processing wireless or wired communication data
A radio transmitter/receiver connected to said baseband processing unit for electrical processing of radio signals for wireless transmission and reception
An antenna device connected to said Radio Transmitter/Receiver for transmission and reception of wireless signal
Memory connected to said processing unit for temporary storage of data and programs
An authentication/billing/card reader unit connected to said processing unit for authentication, card reading and billing entry to be used by users of the client device
A service port controller connected to said processing unit for connecting to the service port
An audio controller connected to said processing unit for controlling response of the audio devices microphone and headphone and speaker
An audio connector connected to said audio controller for connecting audio devices to the client devices
Audio devices connected to said audio controller for audio recording and audio reproduction functionality
Theft deterrence controller connected to said processing unit for controlling theft deterrence response of the client device
Theft sensing module connected to said theft deterrence controller for sending a theft attempt
Theft deterrence system connected to said theft deterrence controller for providing theft deterrence functionality to the client device
Crystal/Clock devices connected to central processing unit for supplying clock to the client device for all digital functionality
LCD controller connected to said processing unit for controlling said LCD screen
Keypad controller connected to said processing unit for controlling the key pad functionality and providing keypad information to said processing unit
A hardwire communication port connected to the processing unit and baseband processing unit for providing wired communication functionality to the client device
Flash memory device connected to said processing unit for storing program and configuration information
Power management unit connected to said processing unit and all other components in the client device for providing power supply to all components of the client device, controlling charging of battery
A supply connector connected to said power management unit for connecting external supply to said power management unit
A battery connected to said power management unit for supplying power to the client device when no external supply is available

19. An onboard wireless digital entertainment, communication & information system as claimed in claim 10 wherein TUDM technique has three modes of operation (i) Disaster mode (ii) Emergency mode and (iii) Normal mode,
when the user presses the disaster button, the client device enters the disaster mode and transmits disaster stress signal including the client device identity in at least one radio frequency, this said signal is received by one or plurality of said scanning devices, thus making it easy to locate the user who has pressed the disaster button, the disaster stress signal transmission is continued till disaster situation is resolved,
when the user presses the emergency button, the client device enters emergency operation mode, the client device sends emergency stress signal to the server, the server activates all emergency time slots and reassigns some of selected user time slots to emergency time slots, number of such time slot reassignment depends on number of free time slots available at that time, the server sends a notification to the supervisor along with the client identity, the supervisor checks the validity of the emergency situation, if the emergency situation exists, the supervisor sends validated emergency stress signal to appropriate authorities and emergency response personnel, the process of notification continues till the emergency situation is resolved,
when the user presses Start button, the client device enters in Normal operation mode

20. An onboard wireless digital entertainment, communication & information system as claimed in claim 19, wherein the client device enters normal operation mode of the said TUDM technique when the Start button is pressed by a user, the user makes a selection from a list of multimedia programs and services displayed on the client device, if the selected program needs a broadcast channel and at least one user is already availing the same program then the new user is assigned the same channel-slot as the old users, but if the selected channel is not a broadcast channel or no other user is already availing the same program then a new channel-slot is assigned to the new user, the server in this case assigns a new program mirror memory and a new unique DMA transfer slot to this new user

21. An onboard wireless digital entertainment, communication & information system as claimed in claim 20, wherein assignment of each channel slot is achieved by a memory map in the server comprising of a circular memory bugger assignment wherein a large memory buffer is allotted for the multimedia content with current time stamp being delivered to the user and small memory buffers allotted for multimedia content with future time stamp such that the time interval between subsequent buffers become larger as time progresses from present to future, similarly, small memory buffers are allotted for multimedia content in the past with time intervals between subsequent buffers such that the time interval becomes larger as the time progresses from present to past

22. An onboard wireless digital entertainment, communication & information system as claimed in claim 21 wherein, the time stamp of the current memory buffer, past memory buffers and future memory buffers are constantly changing with time and the next future memory buffer with next time stamp replaces the past memory buffer with time stamp in farthest past, thus at fixed time interval a new future memory buffer gets created and replaces the past memory buffer with earliest time stamp, this mechanism achieves a circular memory buffer implementation scheme to deliver a seamless on demand multimedia experience using relatively small amount of memory that reduces overall system cost

23. An onboard wireless digital entertainment, communication & information system as claimed in claim 9 wherein said time and user division multiplexing technique, in normal mode of operation, divides all users in small groups, each group comprising of one or multiple users, divides time in small intervals and the interaction between each slot to users is managed by software.

24. An onboard wireless entertainment, communication & information system as claimed in claim 9 wherein said time and user division multiplexing technique in emergency mode assigns priority time slots to emergency users and remaining time slots to non-emergency users wherein, emergency time slots are inserted frequently in interspersed manner to guarantee reliable communication through wireless medium

25. An onboard wireless entertainment, communication & information system as claimed in claim 9 wherein said time and user division multiplexing technique in disaster mode wherein said client devices continuously transmit disaster stress radio signals without interruption and on many available radio frequencies with relevant device identity information for locating an user in disaster situation
